(19) United States
(12) Patent Application Publication
(10) Pub. No.: US 2007/0068775 A1
(43) Pub. Date: Mar. 29, 2007

(54) Method of displacing an object situated on a carrier, as well as a bearing and an assembly

(75) Inventors: Marcus Martinus Petrus Adrianus Vermeulen, EINDHOVEN (NL); Felix Godfried Peter Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/576,161

(22) PCT Filed: Oct. 20, 2004
(86) PCT No.: PCT/IB04/52153

§ 371 Date: Apr. 19, 2006

(30) Foreign Application Priority Data
Oct. 24, 2003 (EP) 03103953.0

(51) Int. Cl. B65G 25/04

(52) U.S. Cl. 198/750.1

(57) ABSTRACT

A method of displacing an object (4) located on a carrier (2). In the carrier (2) an acoustic wave (7) is generated by means of a transducer (3). By means of the acoustic wave (7) generated in the carrier (2) the friction between object (4) and carrier (2) is reduced, while the object is displaced by an external force (Fe). The invention further relates to a bearing (1) as well as an assembly of a plurality of interspaced carriers.

The invention relates to a method of displacing an object located on a carrier, an acoustic wave being generated in the carrier by means of a transducer.

The invention further relates to a bearing for bearing an object, the bearing being provided with a carrier for supporting an object to be placed on the carrier.

The invention also relates to an assembly comprising at least two carriers spaced apart and having each at least one transducer, said carriers supporting an object, acoustic waves traveling in different directions allowing of being generated in the carriers by means of the two transducers.

In such a method known from WO-03/079459 two acoustic waves traveling in opposite directions are generated by a stator by means of two transducers located at least opposite each other. In this way a compound wave is obtained by means of which an element located on the stator is displaceable.

Albeit the method described above is suitable for displacing a displaceable element on a stator, this method has the disadvantage of the compound wave requiring accurate driving of the transducers.

It is an object of the invention to provide a method by which an element can be displaced across a carrier in an accurate and relatively simple manner.

This object is achieved with the method according to the invention in that the friction between object and carrier is reduced by means of the acoustic wave generated in the carrier, while the object is being displaced by means of an external force.

An acoustic wave is generated by means of a transducer to be positioned at random on the carrier, which wave reduces the friction between carrier and object in the desired manner. As a result of the friction between carrier and object, which friction has diminished or even substantially vanished, the object can be displaced over the carrier in a simple way by means of the external force. When turning the transducer off, no waves will be generated any longer, so that the friction between object and carrier will increase. This increased friction will slow down the object displacement by means of the external force, so that an object can be driven in a simple and accurate manner.

With the method according to the invention the friction between object and carrier is reduced or eliminated by means of the transducer, the displacement being executed by means of an external force. This enables the transducer and the external force to be optimized for the function to be executed.

An embodiment according to the inventive method is characterized in that the object is placed between at least two transducers facing each other, the two transducers generating two at least substantially identical waves traveling to each other in opposite directions.

The two separate, substantially identical waves traveling to each other in opposite directions form a compound standing acoustic wave in the carrier surface. This wave provides in a simple manner that in the surface of the carrier the friction between carrier and object is reduced or even substantially gone. Such a compound standing acoustic wave can be formed in a relatively simple manner by applying the same electrical signal to each one of the two identical transducers opposite to each other. After such a standing wave has been generated in the surface of the carrier, the object can be displaced in a simple manner by means of an external force.

As a result of the standing wave it is avoided that the object could be displaced as a result of the waves generated in the carrier.

Another embodiment according to the inventive method is characterized in that the object is displaced by means of an external force in a direction that extends substantially transversely to the direction of the wave traveling through the carrier.

In this manner it is simply guaranteed that the object is displaced in the desired direction only under the influence of the external force.

Another embodiment according to the inventive method is characterized in that the external force is exerted by an acoustic wave generated by means of a further transducer.

In this way the two waves to be generated by means of the two transducers can be optimized for the desired function, one transducer being capable of reducing the friction between the object and the carrier and the other transducer being capable of displacing the object in the desired direction with minimum force.

It is a further object of the invention to provide a bearing for bearing an object in a simple fashion.

This object is achieved with the bearing according to the invention in that an acoustic wave traveling through the surface of the carrier can be generated by means of a transducer, while the object can be bearing-supported on the carrier in a substantially frictionless way by means of the wave.

Bearing an object by means of the acoustic wave is advantageous in that the friction between object and carrier has substantially gone.

A further embodiment of the bearing according to the invention is characterized in that the amplitude of the acoustic wave can be regulated by the transducer.

By regulating the amplitude of the wave, the coefficient of friction between object and bearing can be regulated.

Another embodiment of the bearing according to the invention is characterized in that the transducer can be removably attached to the carrier.

In this way the transducer can be used on a different carrier after an object has been displaced to a desired position on the carrier by the transducer.

A further object of the invention is to provide an assembly for displacing the assembly in a simple manner.

With the assembly according to the invention this object is achieved in that, in operation, contact between the object and the associated carrier can be made by means of one transducer substantially without any friction, whereas the object can be displaced by means of the other transducer.

By making the object on a first carrier substantially frictionless by means of one transducer and by displacing the object by means of another transducer, both transducers can be optimized for the associated function, so that the object can be displaced over both carriers in a simple fashion. By reversing the functions, the object can be displaced in two directions in this way by means of only two transducers.

The invention will be further explained with reference to the drawing in which:

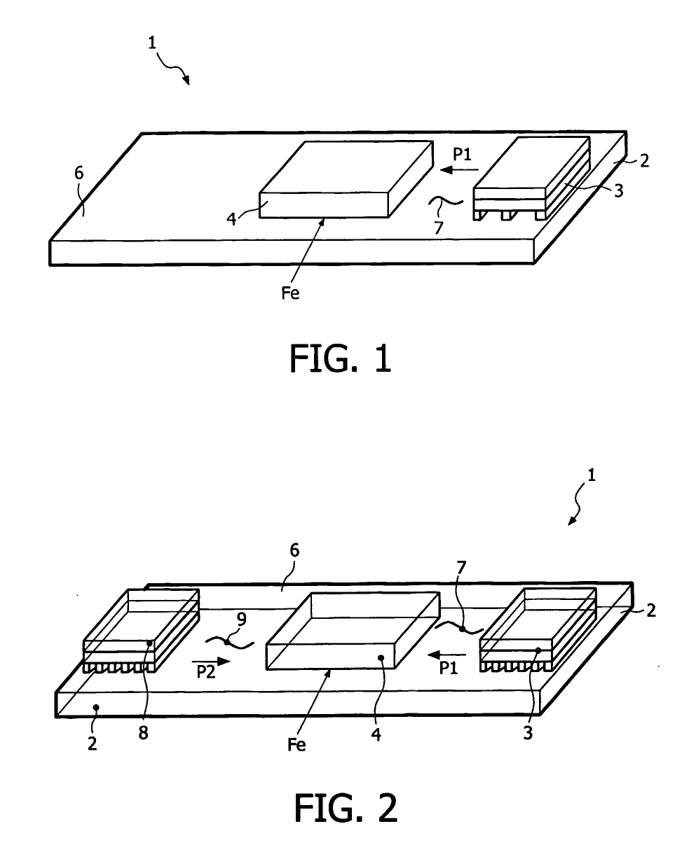

FIG. 1 shows a perspective view of a bearing according to the invention,

FIG. 2 shows a perspective view of another embodiment of a bearing according to the invention, and

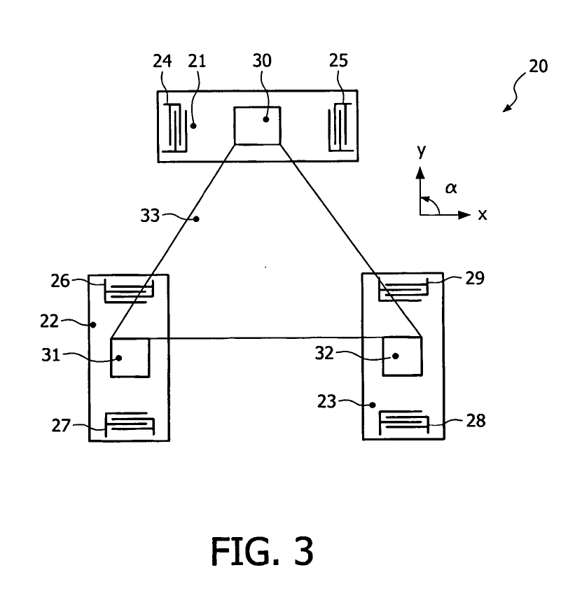

FIG. 3 shows a top plan view of an assembly according to the invention.

In the Figures corresponding elements are referred to by like reference characters.

FIG. 1 shows a perspective view of a bearing 1 according to the present invention. The bearing 1 comprises a carrier 2 and a transducer 3 removably positioned thereon. An object 4 runs on a bearing on the carrier 2.

The transducer 3 is connected to a generator (not shown) by means of which an electrical signal can be produced on the transducer 3 with which signal acoustic waves 7 can be generated in the surface 6. These acoustic waves travel through the surface 6 of the carrier 2 in the direction indicated by the arrow P1.

As a result of the acoustic waves 7 in the surface 6 of carrier 2, which are generated by the transducer 3, the friction between object and surface is strongly reduced. The object 4 is then displaced over the surface 6 by an external force Fe substantially without any friction. For displacing the object 4 in an arbitrary direction, this force Fe can be transferred to the object 4 in that direction running parallel with the surface 6. The force Fe may be, for example, pushing force, magnetic force, tractive force etcetera.

The waves 7 generated in the carrier 2 by the transducer 3 provide a bearing 1 by means of which an object 4 is bearing-supported substantially without any friction.

FIG. 2 shows a perspective view of another embodiment of a bearing 1 according to the invention. In this embodiment an additional transducer 8 is positioned on the carrier 2. The transducer 8 functions similarly to the transducer 3.

Transducer 8 also generates acoustic waves 9 in the surface 6 of the carrier 2. The acoustic waves 9 travel in the direction indicated by the arrow P2.

As is apparent in FIG. 2, the acoustic waves 7, 9 originating from the transducers 3, 8 travel in opposite directions. If the two waves 7, 9 are substantially identical, a compound standing wave is obtained from the combination of the waves 7, 9. Such a standing wave can be simply generated, for example, by supplying the two identical transducers with the same electric signal.

The compound standing wave provides in a simple manner that the friction between carrier 2 and object 4 has substantially vanished while the amplitude of the wave may be relatively large, without the object 4 being displaced over the surface by means of the standing wave. The object 4 is displaced over the surface 6 of the carrier 2 by means of an external force Fe and kept in the desired position.

The transducer 3, 8 may be what is called a comb transducer or a wedge transducer. The transducer 3, 8 can be affixed to the carrier either removably or not, or be integrated with the carrier 2. A transducer integrated with the carrier is for example an inter digital transducer. A transducer of this type is shown in FIG. 3. An inter digital transducer is disposed in a finger-like pattern on a stator surface which is made of a piezo-electric material.

FIG. 3 shows a top plan view of an assembly 20 according to the invention. The assembly 20 comprises three carriers 21, 22, 23 positioned apart. Each carrier 21, 22, 23 has two transducers 24, 25, 26, 27, 28, 29 as well as an object 33 supported by the carriers 21, 22, 23, the object 33 being supported by the carriers 21, 22, 23 by means of the supporting elements 30, 31, 32.

If the object 33 is to be displaced in the direction indicated by the arrow y or a direction opposite to that, an compound acoustic standing wave is generated in carrier 21 by the transducers 24, 25, so that the object 33 can be displaced in frictionless manner over the surface of the carrier 21 by means of an external force. The transducers 26, 27, 28, 29 generate two corresponding compound waves in the two carriers 22, 23. These compound waves generate an external force by which the object 33 is displaced in the direction indicated by the arrow y or a direction opposite thereto. Since the contact between object 33 and the carrier 21 is substantially frictionless, the supporting element 30 of the object 33 can be displaced by the external force in the direction indicated by the arrow y substantially without any friction. For example by driving the respective transducers 26, 27 and 28, 29 in opposite directions, a rotation in or opposite to the direction indicated by the arrow X can be generated.

If the object 33 is to be displaced in the direction indicated by the arrow X or a direction opposite thereto, two compound standing waves are generated in the two carriers 22, 23 by means of the transducers 26, 27, 28, 29, after which the object 33 can be displaced over the carriers by means of an external force without any friction. By generating a compound acoustic wave in the carrier 21 by means of the transducers 24, 25, an external force can be generated by which the object 33 is displaced over the surfaces of the carriers 21, 22, 23 in the direction indicated by the arrow x or a direction opposite thereto.

Having the object 4, 33 slow down is made possible by having the friction increase again, which is possible by discontinuing the waves generated by the transducer(s) by means of which the friction was reduced. It is alternatively possible to have an external force slow down the displacing object.

Further it is possible to provide an assembly of only two carriers, or an assembly of more than three carriers.

Furthermore it is possible to provide the carriers 21, 22, 23 with an assembly of a single transducer. If the friction is to be reduced, the running acoustic waves generated in the carriers 21, 22, 23 by means of these transducers should not have too large amplitudes so as to avoid the waves displacing the object relative to the carrier. The acoustic waves generated as an external force by means of the transducer are to have an amplitude that is large enough for displacing the object 33.

The wave amplitude can be regulated by means of the electrical signal applied to the transducer.

It is alternatively possible for a single carrier to be provided with two pairs of transducers extending for example transversely to each other.

1. A method of displacing an object (4) located on a carrier (2), an acoustic wave (7) being generated in the carrier (2) by means of a transducer (3), characterized in that the friction between object (4) and carrier (2) is reduced by means of the acoustic wave (7) generated in the carrier (2), while the object (4) is being displaced by means of an external force (Fe).

2. A method as claimed in claim 1, characterized in that the object (4) is placed between at least two transducers (3, 8) facing each other, the two transducers (3, 8) generating two at least substantially identical waves (7, 9) traveling to each other in opposite directions.

3. A method as claimed in claim 1, characterized in that the object (4) is displaced by means of the external force (Fe) in a direction that extends substantially transversely to the direction (P1, P2) of the wave (7, 9) traveling through the carrier (2).

4. A method as claimed in claim 1, characterized in that the external force (Fe) is exerted by an acoustic wave generated by means of a further transducer.

5. A bearing for bearing-mounting an object, the bearing (1) being provided with a carrier (2) for supporting an object (4) to be placed on the carrier (2), characterized in that the bearing (1) includes a transducer (3) by means of which an acoustic wave (7) traveling through the surface (6) of the carrier (2) can be generated, while the object (4) can be bearing-mounted on the carrier (2) in a substantially frictionless manner by means of the wave (7).

6. A bearing as claimed in claim 5, characterized in that the amplitude of the acoustic wave (7) can be regulated by means of the transducer (3).

7. A bearing as claimed in claim 6, characterized in that the transducer (3) can be removably attached to the carrier (2).

8. An assembly (20) comprising at least two carriers (21, 22, 23) spaced apart, having each at least one transducer (24-29), said carriers (21, 22, 23) supporting an object (33), acoustic waves traveling in different directions in the carriers (21, 22, 23) being producible by means of the two transducers (24-29), characterized in that, in operation, contact between the object (33) and the associated carrier (21, 22, 23) can be made by means of one transducer (24-29) substantially without any friction, whereas the object (33) can be displaced by means of the other transducer (24, 29).
